(19) United States
(12) Patent Application Publication
(10) Pub. No.: US 2021/0367299 A1
(43) Pub. Date: Nov. 25, 2021

(54) BATTERY CELL

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/326,343

(22) Filed: May 21, 2021

(30) Foreign Application Priority Data
May 25, 2020 (JP) 2020-090568

(51) Int. Cl. H01M 50/197; H01M 50/533; H01M 50/105; H01M 50/557; H01M 50/124

(52) U.S. Cl. CPC H01M 50/197; H01M 50/533; H01M 50/124; H01M 50/557; H01M 50/105

(57) ABSTRACT

To enhance stiffness of a battery ceil and avoid cracking of an electrode without a reinforcement member in the battery cell configured such that a battery is covered with an exterior body including a laminated film. A battery cell includes a battery and an exterior body housing the battery. The exterior body includes a film in which a plurality of layers is stacked on each other, and the plurality of layers includes a surface layer to be a stiffness reinforcing layer, an air blocking layer, and an inner layer to be an adhesive layer. A buffer layer made of polyethylene terephthalate may be interposed between the air blocking layer and the inner layer. Moreover, an adhesive layer may be interposed between the air blocking layer and the surface layer. Further, a waterproof layer made of polypropylene or polyethylene terephthalate may be provided outside the air blocking layer.

This application is based on and claims the benefit of priority from Japanese Patent Application 2020-090568, filed on 25 May 2020, the content of which is incorporated herein by reference.

### BACKGROUND OF THE INVENTION

### Field of the Invention

The present invention relates to a battery cell, and particularly relates to a battery cell sealed by an exterior body.

### Related Art

In recent years, a demand for high-capacity high-output battery devices has rapidly grown due to popularization of various types of electric/electronic equipment with a variety of sizes, such as an automobile, a personal computer, and a mobile phone. Examples of these battery devices include a liquid battery cell using, as an electrolyte, an organic electrolytic solution between positive and negative electrodes and a solid-state battery cell using a fire-retardant solid electrolyte instead of using the organic electrolytic solution as the electrolyte.

For these battery devices, a laminated cell type battery ceil configured such that a battery is sealed in a plate shape with the battery being covered with a laminated film (an exterior body) is known. For a purpose such as an EV or an HEV, a battery cell assembly configured such that multiple laminated cell type battery cells as described above are arranged and housed in a case has been used. The battery is covered with the exterior body so that entry of atmospheric air into the battery can be prevented (e.g., Japanese Unexamined Patent Application, Publication No. 2012-169204). Note that in the present specification, the “battery” indicates a member including a battery element stack having positive and negative electrodes and an electrolyte and a collection tab lead, and one sealed with a battery being covered with a laminated film (an exterior body) will be referred to as a “battery cell”.

For the purpose of effectively improving the volumetric energy density of a battery module while maintaining sealability of a laminated film (an exterior body), a battery cell including an exterior body configured such that a single film is folded to house a battery is disclosed (WO2019/188825). According to WO2019/138825, this battery cell can effectively improve the volumetric energy density of the battery module while maintaining the sealability of the exterior body.

Patent Document 1: Japanese Unexamined Patent Application, Publication No. 2012-169204

Patent Document 2: WO2019/188825

### SUMMARY OF THE INVENTION

In the battery cell configured such that the battery is covered with the exterior body including the laminated film, the laminated film itself does not have a sufficient strength for protecting the battery from external force. For this reason, stiffness of the battery cell is not considered as sufficiently high, and in a case where the external force is on the battery cell, problems such as cracking of the electrode are caused. Thus, a reinforcement member for preventing cracking of the electrode needs to be arranged. However, in a case where the reinforcement member is arranged, problems such as an increase in the weight of the battery cell and a decrease in the energy density of the battery formed as a module are caused.

The present invention has been made in view of the above-described problems on the battery cell, and an object of the present invention is to enhance stiffness of a battery cell and avoid cracking of an electrode without a reinforcement member in the battery cell configured such that a battery is covered with an exterior body including a laminated film.

For solving the above-described problems, the battery cell of the present invention is a battery cell including a battery and an exterior body housing the battery. The exterior body includes a film in which a plurality of layers is stacked on each other, and the plurality of layers includes a surface layer to be a stiffness reinforcing layer, an air blocking layer, and an inner layer to be an adhesive layer.

The exterior body of the battery cell includes the film in which the plurality of layers including the surface layer to be the stiffness reinforcing layer, the air blocking layer, and the inner layer to be the adhesive layer is stacked on each other. With this configuration, the exterior body itself can have strength, the battery can be protected in such a manner that the battery is packaged in the exterior body, which includes the film in which the plurality of layers is stacked on each other, with the battery being covered with the exterior body, and cracking of an electrode can be reduced.

In the present invention, in this case, the thickness of the surface layer is 0.1 to 1 mm and preferably 0.25 to 0.6 mm. In a case where the thickness of the surface layer is less than 0.1 mm, the surface layer cannot ensure strength as the stiffness reinforcing layer. In a case where the thickness exceeds 1 mm, a problem in reducing weight of the battery cell is caused, and a difficulty in folding of the exterior body for packaging the battery in the exterior body with the battery being covered with the exterior body is caused.

In the present invention, in this case, the surface layer to be the stiffness reinforcing layer is made of cellulose. For example, paper made of cellulose is suitable for maintaining strength. Moreover, such paper is lightweight and easily foldable, and therefore, is most suitable as the material of the stiffness reinforcing layer.

In the present invention, in this case, the inner layer to be the adhesive layer is made of polypropylene.

Polypropylene starts melting at about 140° C. Thus, an inner surface can be coated with polypropylene as the inner layer, and upon bonding, polypropylene can be heated and thermally welded at a temperature of equal to or higher than 140° C. Polypropylene is most suitable as the material of the inner layer to be the adhesive layer because necessary portions can be bonded by a simple step. As the material of the air blocking layer, aluminum foil or stainless steel (SUS) foil is most suitable as long as the material is lightweight and can block air.

In the present invention, in this case, a buffer layer made of polyethylene terephthalate may be interposed between the air blocking layer and the inner layer. An adhesive layer may be interposed between the air blocking layer and the surface layer. A waterproof layer made of polypropylene or polyethylene terephthalate may be provided outside the air blocking layer. These layers enhance elasticity and waterproof properties of the film of the exterior body and adhesion among the layers, and improve various functions of the film as the exterior body.

In the present invention, in this case, the exterior body includes a portion in contact with and covering a top surface, a bottom surface, and two side surfaces of the battery perpendicular to an end surface from which a collection tab lead of the battery extends, a portion covering the end surface from which the collection tab lead of the battery protrudes, folded in from each short side of the end surface to form a triangular pyramid-shaped space on each side, and folded from each long side of the end surface to cover the end surface, and a portion further extending in an axial direction from the portion covering the end surface such that both opposing upper and lower surfaces are joined to each other to sandwich the collection tab lead.

In the present invention, in this case, the film of the exterior body includes a portion covering in contact with the top surface, the bottom surface, and the two side surfaces of the battery perpendicular to an end surface from which the collection tab lead of the battery extends, a portion covering the end surface from which the collection tab lead of the battery protrudes, folded in from each short side of the end surface to form the triangular pyramid-shaped space on each side, and folded from each long side of the end surface to cover the end surface, and a portion further extending in an axial direction from the portion covering the end surface such that both opposing upper and lower surfaces are joined to each other to sandwich the collection tab lead.

The above-described form of the exterior body is particularly a form corresponding to the collection tab lead and the battery including the end surface from which the collection tab lead protrudes. The end surface from which the collection tab lead protrudes can be efficiently covered and sealed, the collection tab lead can be sandwiched with both upper and lower surfaces thereof being covered, and the battery from which the collection tab lead protrudes can be efficiently packaged by a smaller number of steps.

In the present invention, in this case, the battery is an all-solid-state battery including a stack with a solid electrolyte.

The all-solid-state battery cell is brittle and easily damaged particularly at a corner portion and an end surface. For this reason, the exterior, body of the present invention including the stiffness-reinforced film in which the plurality of layers including the surface layer to be the stiffness reinforcing layer, the air blocking layer, and the inner layer to be the adhesive layer is stacked on each other is particularly effective as a film to be applied to the all-solid-state battery cell.

According to the present invention, the exterior body includes the film in which the plurality of layers including the surface layer to be the stiffness reinforcing layer, the air blocking layer, and the inner layer to be the adhesive layer is stacked on each other, and therefore, the exterior body itself can have strength. Thus, the following features and advantageous effects are provided: the battery can be protected in such a manner that the battery is packaged in the exterior body, which includes the film in which the plurality of layers is stacked on each other, with the battery being covered with the exterior body, and cracking of an electrode can be reduced.

### BRIEF DESCRIPTION OF THE DRAWINGS

FIG. 1 is a perspective view of a battery in a battery cell of the present invention;

FIG. 2 is a perspective view showing an outer appearance of the battery cell of the present, invention;

FIG. 3 is a development view of an exterior body of the battery cell of the present invention; and

FIG. 4 is a sectional view of a film of the exterior body of the battery cell of the present invention.

### DETAILED DESCRIPTION OF THE INVENTION Hereinafter, one embodiment of the present invention will be described in detail with reference to the drawings.

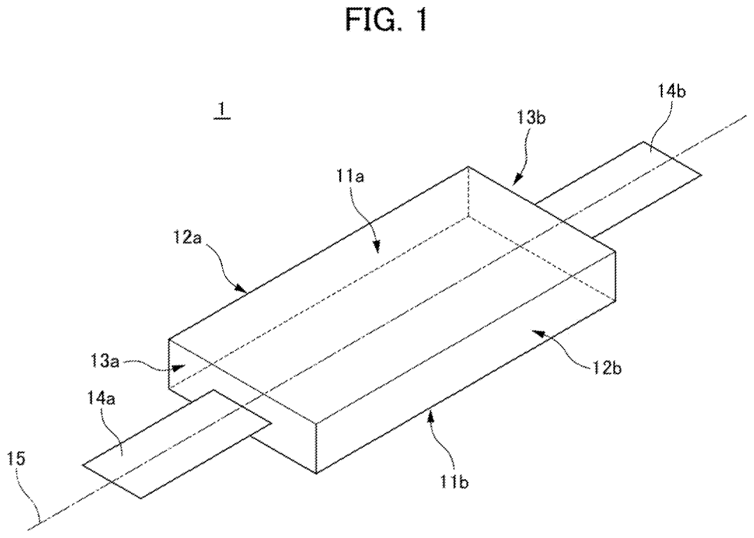

A battery 1 of the present invention is an all-solid-state battery in the embodiment, and is in a rectangular parallelepiped shape as shown in FIG. 1. The battery 1 has six surfaces including a top surface 11a, a bottom surface 11b, side surfaces 12a, 12b, and end surfaces 13a, 13b. Assuming a center axis 15 connects the centers of the end surfaces 13a, 13b to each other, each of collection tab leads 14a, 14b is provided to extend in the direction of the center axis 15 from a corresponding one of the end surfaces 13a, 13b. The all-solid-state battery is brittle and easily damaged particularly at a corner portion and a surface portion (an end surface portion), and for this reason, is more suitable for application of the configuration of each embodiment of the present invention.

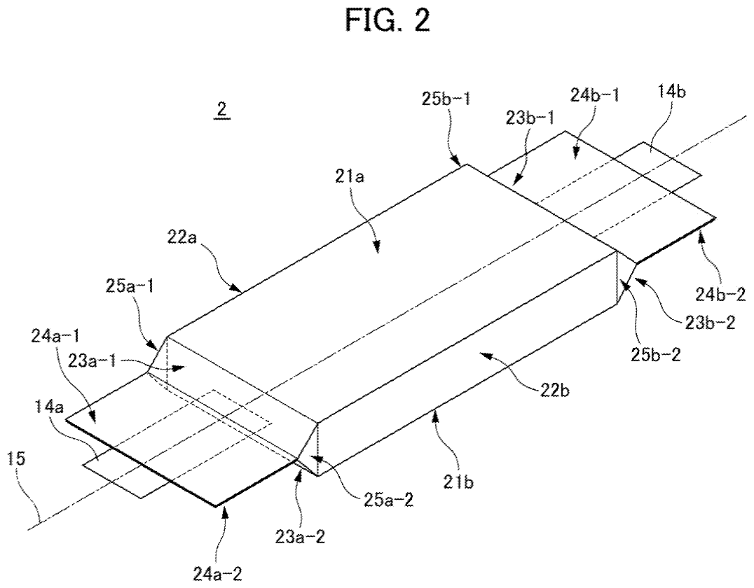

FIG. 2 shows a battery cell 2 configured such that the battery 1 of FIG. 1 is packaged in an exterior body 3 with the battery 1 being covered with the exterior body 3.

In the battery cell 2, a top surface 21a, a bottom surface 21b, and side surfaces 22a, 22b are defined corresponding to the battery 1. Portions corresponding to the end surfaces 13a, 13b of the battery 1 are end surface folding portions 23a-1, 23a-2, 23b-1, 23b-2 in such a form that the exterior body 3 is folded, and have appearances in a triangular prism shape. At the end surface folding portions 23a-1, 23a-2, 23b-1, 23b-2, the total of four triangular pyramid-shaped spaces 25a-1, 25a-2, 25b-1, 25b-2 formed by folding-in of the portions 23a-1, 23a-2, 23b-1, 23b-2 from side surface 22a, 22b sides are formed two on each side. Collection tab lead housing portions 24a-1, 24a-2, 24b-1, 24b-2 vertically sandwiching and housing the collection tab leads 14a, 14b are provided to extend in the direction of the center axis 15 from the end surface folding portions 23a-1, 23a-2, 23b-1, 23b-2.

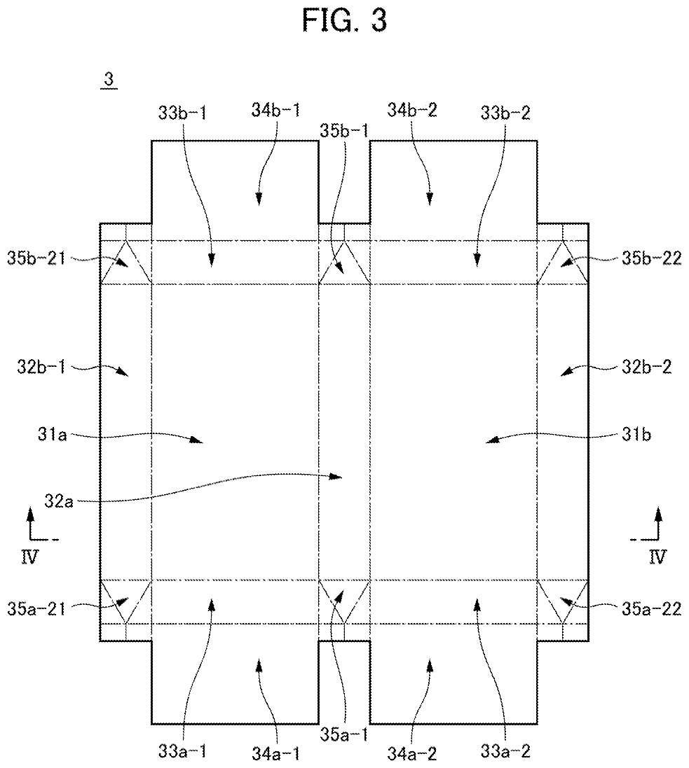

FIG. 3 shows a development view of the exterior body 3. The exterior body 3 has a top surface covering portion 31a and a bottom surface covering portion 31b as portions each covering the top surface 11a and the bottom surface 11b of the battery 1, has a side surface covering portion 32a as a portion covering the side surface 12a, and has side surface covering portions 32b-1, 32b-2 as portions covering the side surface 12b. The side surface covering portions 32b-1, 32b-2 are joint portions overlapping with and joined to each other when the battery 1 is covered with the exterior body 3. Thus, the side surface 12a of the battery 1 is doubly covered with the side surface covering portions 32b-1, 32b-2 of the exterior body 3.

As portions covering the end surfaces 13a, 13b of the battery 1, end surface covering portions 33a-1, 33a-2, 33b-1, 33b-2 forming the triangular prism-shaped end surface folding portions 23a-1, 23a-2, 23b-1, 23b-2 of the battery cell 2 in the form that the exterior body 3 is folded are provided corresponding to an upper-lower, direction of the end surface on each side. As extensions of the end surface covering portions 33a-1, 33a-2, 33b-1, 33b-2 in the center axis 15 direction, collection tab lead sandwiching portions 34a-1, 34a-2, 34b-1, 34b-2 vertically sandwiching the collection tab leads on both sides are provided. As portions forming the triangular pyramid-shaped spaces 25a-1, 25a-2, 25b-1, 25b-2 formed folded in from the side surface 22a, 22b sides, triangular pyramid-shaped space formation portions 35a-1, 35a-21, 35a-22, 35b-1, 35b-21, 35b-22 are formed. The triangular pyramid-shaped space formation portions 35a-21, 35a-22 overlap with each other to form the triangular pyramid-shaped space, and the triangular pyramid-shaped space formation portions 35b-21, 35b-22 overlap with each other to form the triangular pyramid-shaped space.

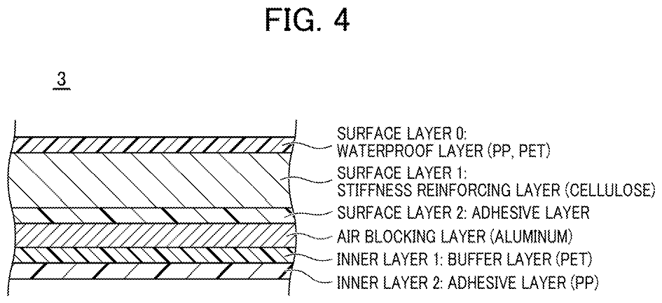

Part of the section of a film of the exterior body 3 cut along an IV-IV line of FIG. 3 is shown in FIG. 4. That is, the film of the exterior body 3 includes, as shown in FIG. 4, a stack of six layers including a surface layer 0, a surface layer 1, a surface layer 2, an air blocking layer, an inner layer 2, and an inner layer 1 in this order from the top (the outside).

The surface layer 0 is a layer forming an outermost layer of the film of the exterior body 3, and as a waterproof layer, is made of a resin material such as polypropylene (PP) or polyethylene terephthalate (PET). The surface layer 1 is a stiffness reinforcing layer for ensuring stiffness of the film of the exterior body 3, and is made of cellulose paper. In the battery cell 2 of the present invention, the exterior body 3 has such a shape that the battery 1 is packaged in the exterior body 3 with the battery 1 being covered with the exterior body 3, and such a shape is formed by the process of folding the film of the exterior body 3. Thus, e.g., the cellulose paper which is easily foldable, is lightweight, and has a sufficiently-high strength is most suitable as the material of the exterior body 3. Note that the cellulose paper exhibits a small water repellent effect, and for this reason, in a case where the cellulose paper is used for the surface layer 1 as the stiffness reinforcing layer, the waterproof layer of the surface layer 0 needs to be used as a layer for waterproofing on the surface layer 1.

As described above, in the battery cell 2 of the present invention, the shape of the exterior body 3 for packaging the battery 1 in the exterior body 3 with the battery 1 being covered with the exterior body 3 is formed by the folding process. Thus, the thickness of the exterior foody 3 can be greater than that In a case where the exterior foody 3 is formed using a technique such as deep drawing. Specifically, the thickness of the surface layer 1 as the stiffness reinforcing layer is 0.1 to 1 mm and preferably 0.25 to 0.6 mm. In a case where the thickness of the surface layer 1 is less than 0.1 mm, the surface layer 1 cannot ensure strength as the stiffness reinforcing layer. In a case where the thickness exceeds 1 mm, a problem in reducing weight of the battery cell 2 is caused, and a difficulty in folding of the exterior body 3 for packaging the battery 1 in the exterior body 3 with the battery 1 being covered with the exterior body 3 is caused.

The surface layer 2 fulfills a role as an adhesive layer between the surface layer 1 and the air blocking layer. The inner layer 2 made of polyethylene terephthalate (PET) is provided as a buffer layer inside the air blocking layer. The inner layer 1 made of polypropylene (PP) is provided as an adhesive layer below (inside) the inner layer 2. Polypropylene (PP) starts melting at about 140° C. Thus, an inner surface of the inner layer 2 is coated with polypropylene (PP) as the inner layer 1, and upon bonding for forming the shape of a package for covering the battery 1 with the exterior body 3, polypropylene (PP) is heated and thermally welded at a temperature of equal to or higher than 140° C. In this manner, the shape of the package can be formed. Polypropylene is most suitable as the material of the inner layer 1 to be the adhesive layer because necessary portions can be bonded by a simple step.

Of the six layers of the surface layer 0, the surface layer 1, the surface layer 2, the air blocking layer, the inner layer 1, and the inner layer 2 forming the stack of the film of the exterior body 3, the stiffness reinforcing layer of the surface .layer 1, the air blocking layer, and the adhesive layer of the inner layer 2 are, in the present invention, essential basic constituent layers, and the other layers are layers added as necessary.

The embodiment of the present invention has been described above with reference to the example, but the present invention is not limited to such an example. Needless to say, various forms can be made without departing from the gist of the present invention.

### EXPLANATION OF REFERENCE NUMERALS

1 Battery
11a Top Surface
11b Bottom Surface
12a, 12b Side Surface
13a, 13b End Surface
14a, 14b Collection Tab Lead
15 Center Axis
2 Battery Cell
21a Top Surface
21b Bottom Surface
22a, 22b Side Surface
23a-1, 23a-2, 23b-1, 23b-2 End Surface Folding Portion
24a-1, 24a-2, 24b-1, 24b-2 Collection Tab Lead Housing Portion
25a-1, 25a-2, 25b-1, 25b-2 Triangular Pyramid-Shaped Space
3 Exterior Body
31a Top Surface Covering Portion
31b Bottom Surface Covering Portion
32a, 32b-1, 32b-2 Side Surface Covering Portion
33a-1, 33a-2, 33b-1, 33b-2 End Surface Covering Portion
34a-1, 34a-2, 34b-1, 34b-2 Collection Tab Lead Sandwiching Portion
35a-1, 35a-21, 35a-22, 35b-1, 35b-21, 35b-22 Triangular Pyramid-Shaped Space Formation Portion

What is claimed is:

1. A battery cell comprising:
a battery; and
an exterior body housing the battery,
wherein the exterior body includes a film in which a plurality of layers is stacked on each other, and the plurality of layers includes a surface layer to be a stiffness reinforcing layer, an air blocking layer, and an inner layer to be an adhesive layer.

2. The battery cell according to claim 1, wherein a thickness of the surface layer is 0.1 to 1 mm.

3. The battery cell according to claim 1, wherein a thickness of the surface layer is 0.25 to 0.6 mm.

4. The battery cell according to claim 1, wherein the surface layer is made of cellulose.

5. The battery cell according to claim 1, wherein the air blocking layer is made of aluminum foil.

6. The battery cell according to claim 1, wherein the inner layer is made of polypropylene.

7. The battery ceil according to claim 1, wherein a buffer layer is interposed between the air blocking layer and the inner layer.

8. The battery cell according to claim 7, wherein the buffer layer is made of polyethylene terephthalate.

9. The battery cell according to claim 1, wherein an adhesive layer is interposed between the air blocking layer and the surface layer.

10. The battery ceil according to claim 1, wherein a waterproof layer is provided outside the air blocking layer.

11. The battery cell according to claim 10, wherein the waterproof layer is made of polypropylene or polyethylene terephthalate.

12. The battery cell according to claim 1, wherein the exterior body includes a portion covering in contact with a top surface, a bottom surface, and two side surfaces of the battery perpendicular to an end surface from which a collection tab lead of the battery extends, a portion covering the end surface from which the collection tab lead of the battery protrudes, folded in from each short side of the end surface to form a triangular pyramid-shaped space on each side, and folded from each long side of the end surface to cover the end surface, and a portion further extending in an axial direction from the portion covering the end surface such that both opposing upper and lower surfaces are joined to each other to sandwich the collection tab lead.

13. The battery cell according to claim 1, wherein the battery is an all-solid-state battery including a stack with a solid electrolyte.
